(19) United States
(12) Patent Application Publication
(10) Pub. No.: US 2025/0083347 A1
(43) Pub. Date: Mar. 13, 2025

(54) HAIR CLIPPER WITH ELECTRIC FAN FOR HEAT DISSIPATION

(71) Applicant: GUANGZHOU LIZHUANG ELECTRICAL TECHNOLOGY CO., LTD., Guangzhou (CN)

(72) Inventor: ZHUANG LI, Guangzhou (CN)

(21) Appl. No.: 18/804,224

(22) Filed: Aug. 14, 2024

(30) Foreign Application Priority Data
Sep. 12, 2023 (CN) 202322465047.2

(51) Int. Cl. B26B 19/38

(52) U.S. Cl. CPC B26B 19/3873; B26B 19/382

(57) ABSTRACT

A hair clipper with an electric fan for heat dissipation is provided, which includes a hair clipper housing. An end of the hair clipper housing is provided with an accommodation chamber, a side wall of the accommodation chamber is rotatably connected to an electric shaft. A first bevel gear is fixedly connected to an outer wall of the electric shaft. A surface of the hair clipper housing is provided with an installation groove, four sets of corners on an inner wall of the installation groove are provided with an insertion slot. An interior of the installation groove is provided with a heat dissipation component that includes a fixed frame being inserted into the interior of the installation groove. In this hair clipper, the hair clipper is started and the electric shaft drives a blade to work while driving the first bevel gear and a second bevel gear to rotate.

### CROSS-REFERENCE TO RELATED APPLICATIONS

This application claims priority to Chinese Patent Application No. 202322465047.2, filed on Sep. 12, 2023, which is hereby incorporated by reference in its entirety.

### TECHNICAL FIELD

The present disclosure relates to the field of hair clipper technologies, and in particular, to a hair clipper with an electric fan for heat dissipation.

### BACKGROUND

An electric hair clipper is a hair cutting tool that uses an electric motor so as to drive a blade to move. It usually includes an electric motor and an adjustable blade, which completes a hair cutting process through the power of the electric motor. Th electric hair clipper typically has different cutting length settings that can be adjusted according to a user's needs. The electric hair clipper is easy to operate, efficient and fast, suitable for various hair cutting and styling needs.

However, prolonged use of these traditional hair clippers may cause issues such as heat concentration and lack of breathability. When in contact with the scalp and hair, the surface temperature of the hair clipper may be too high, which may pose a risk of discomfort or burns to the user. In view of this, the present application proposes a hair clipper with an electric fan for heat dissipation.

### SUMMARY

In view of the shortcomings of the existing technology, the present disclosure provides a hair clipper with an electric fan for heat dissipation, which solves the problem of “prolonged use of these traditional hair clippers may cause heat concentration, lack of breathability, and a surface temperature of the hair clipper may be too high, which may pose a risk of discomfort or burns to a user when contact with the scalp and hair” in the background technology.

In order to achieve the above objectives, the present disclosure is implemented through the following technical solutions: a hair clipper with an electric fan for heat dissipation, including a hair clipper housing, where an end of the hair clipper housing is provided with an accommodation chamber, a side wall of the accommodation chamber is rotatably connected to an electric shaft; a first bevel gear is fixedly connected to an outer wall of the electric shaft; a surface of the hair clipper housing is provided with an installation groove, the four sets of corners on an inner wall of the installation groove are respectively provided with an insertion slot; an interior of the installation groove is provided with a heat dissipation component, and the heat dissipation component includes a fixed frame, the fixed frame is inserted into the interior of the installation groove; a surface and a bottom of the fixed frame are both connected with a protective strip; a surface of the protective strip is provided with a ventilation groove; a through hole that is penetrated is provided on the surface of the protective strip, and the through hole is rotatably connected with a rotating shaft, the rotating shaft is penetrated and fixedly connected to a surface of a circular plate, a side wall of the circular plate is fixedly connected with a blade; a bottom of the rotating shaft is fixedly connected with a second bevel gear, and the second bevel gear meshes with the first bevel gear.

In some embodiment of the present disclosure, a positioning component is provided on a surface of the fixed frame, the positioning component includes a sliding groove, the sliding groove is provided on the surface of the fixed frame, an interior of the sliding groove is slidably connected with a slider, and the slider is elastically connected to an inner wall of the sliding groove through a reset spring; an end of the slider is fixedly connected to an insertion plate, and the insertion plate penetrates and is slidably connected to a side wall of the fixed frame.

In some embodiment of the present disclosure, a baffle is fixedly connected to a surface of the fixed frame.

In some embodiment of the present disclosure, there are a plurality sets of blades that are distributed on the side wall of the circular plate in an array.

In some embodiment of the present disclosure, the circular plate and blades are arranged between two sets of protective strips.

In some embodiment of the present disclosure, the insertion plate is inserted into an interior of the insertion slot.

In some embodiment of the present disclosure, a surface of the slider is provided with a plurality sets of grooves that are distributed in an array.

In some embodiment of the present disclosure, a height of the slider is greater than a depth of the sliding groove.

The present disclosure provides a hair clipper with an electric fan for heat dissipation, which has the following beneficial effects.

When using the hair clipper with an electric fan for heat dissipation, the hair clipper is started, the electric shaft drives the first bevel gear to rotate when working, and the second bevel gear that is meshed with the first bevel gear is simultaneously rotated, so that a plurality sets of blades are rotated, thereby accelerating an air flow inside the accommodation chamber, dissipating the accumulated heat inside, and cooling the blade head.

### BRIEF DESCRIPTION OF DRAWINGS

FIG. 1 is a schematic diagram of an overall structure of the present disclosure.

FIG. 2 is a schematic structural diagram of an end of a hair clipper housing of the present disclosure.

FIG. 3 is a schematic structural diagram of a side view of a heat dissipation component of the present disclosure.

FIG. 4 is a schematic structural diagram of a top of the heat dissipation component of the present disclosure.

Numeral reference: 1—hair clipper housing; 2—accommodation chamber; 3—electric shaft; 31—first bevel gear; 4—installation groove; 5—heat dissipation component; 51—fixed frame; 52—baffle; 53—protective strip; 54—ventilation groove; 55—rotating shaft; 56—circular plate; 57—blade; 58—second bevel gear; 6—positioning component; 61—sliding groove; 62—slider; 63—reset spring; 64—insertion plate.

### DESCRIPTION OF EMBODIMENTS

The following will provide a clear and complete description of the technical solution in the embodiments of the present disclosure, based on the accompanying drawings. Obviously, the described embodiments are only a part of the embodiments of the present disclosure, not all of them. Based on the embodiments in the present disclosure, all other embodiments obtained by those skilled in the art without creative work are within the protection scope of the present disclosure.

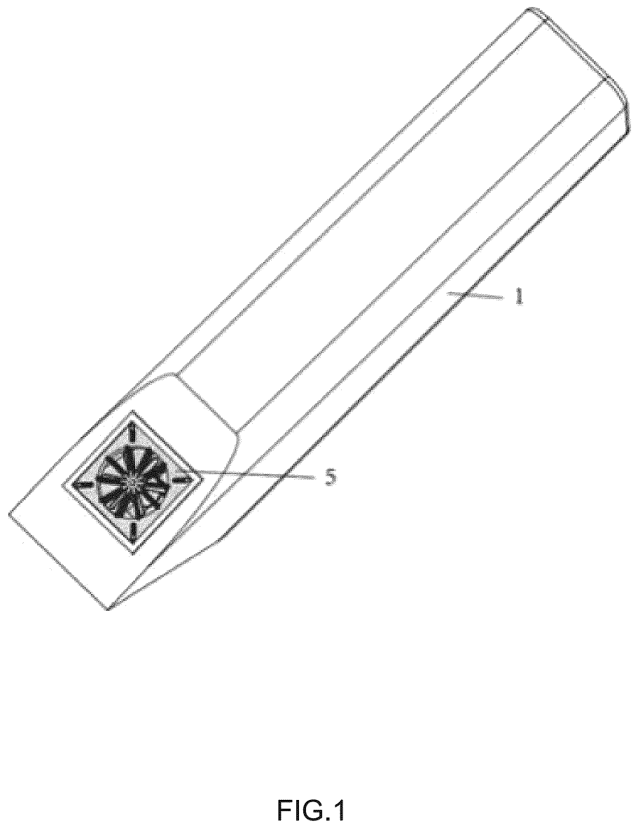

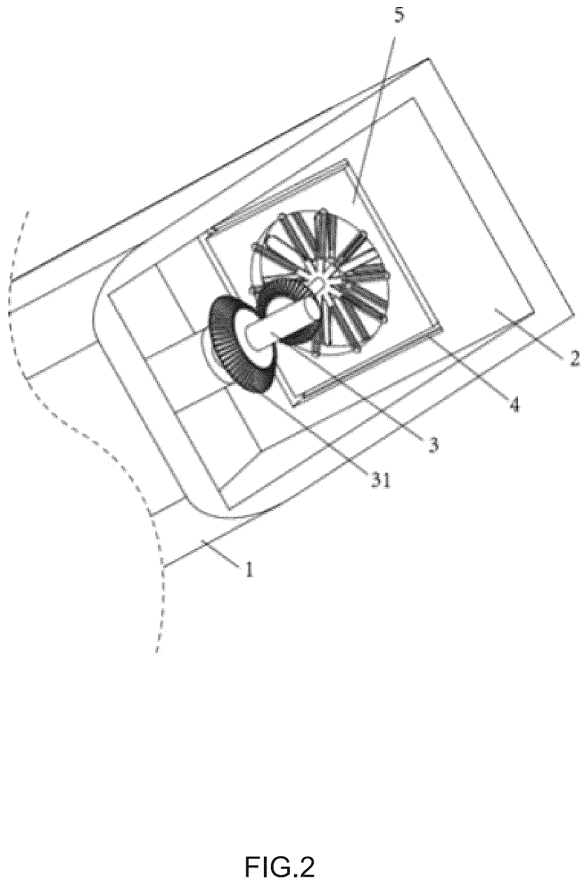

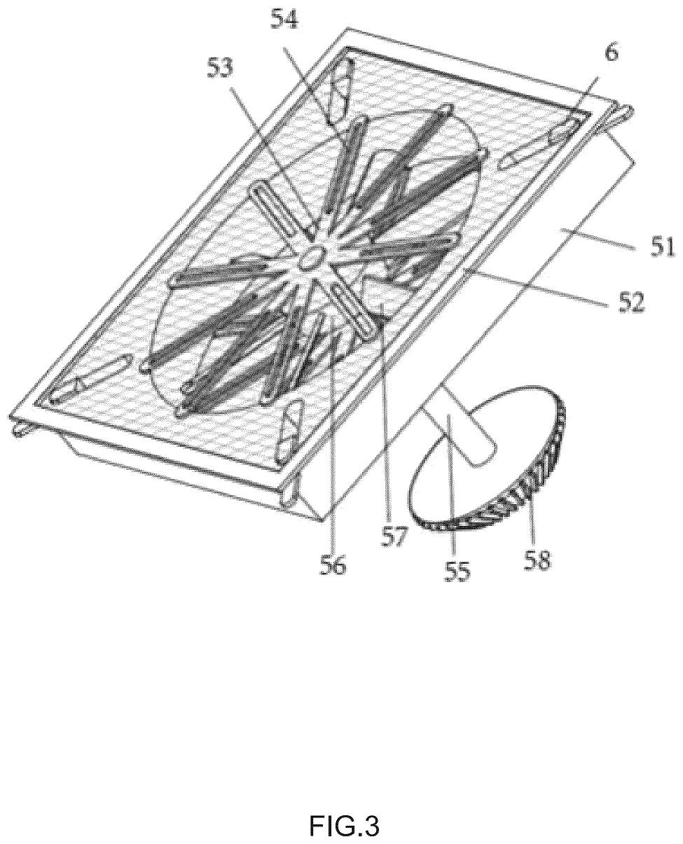

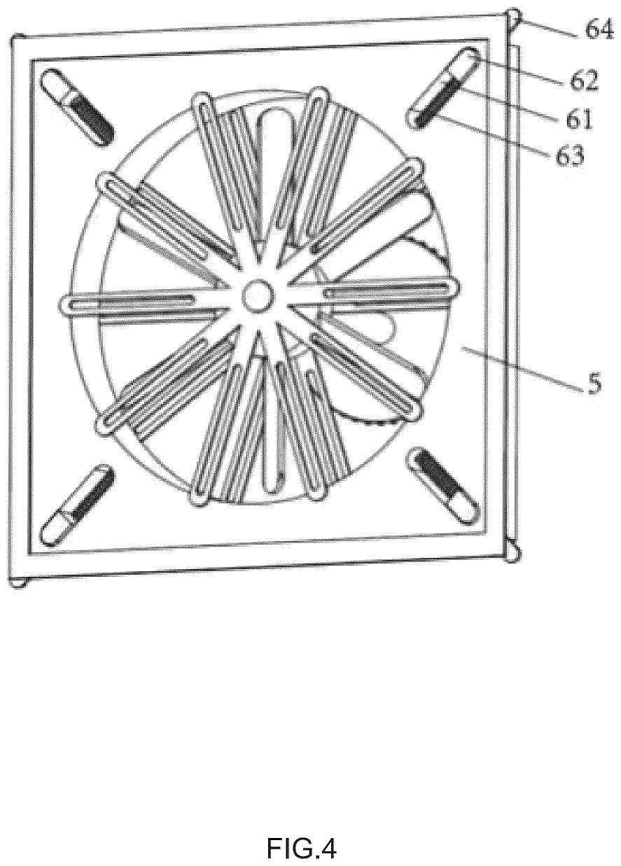

Please refer to FIGS. 1-4. The present disclosure provides a hair clipper with an electric fan for heat dissipation, which includes a hair clipper housing 1. An end of the hair clipper housing 1 is provided with an accommodation chamber 2, an interior of the accommodation chamber 2 is configured to install a blade, a side wall of the accommodation chamber 2 is rotatably connected to an electric shaft 3. An end of the electric shaft 3 is fixedly connected to an output shaft of a motor for driving the blade and the heat dissipation component 5. A first bevel gear 31 is fixedly connected to an outer wall of the electric shaft 3, and an installation groove 4 is provided on a surface of the hair clipper housing 1. Four sets of corners on an inner wall of the installation groove 4 are provided with an insertion slot. The installation groove 4 allows air circulation inside the accommodation chamber 2 and cooperates with the insertion slot to facilitate the installation and positioning of the heat dissipation component 5. The heat dissipation component 5 is installed inside the installation groove 4, mainly to accelerate the air flow speed inside the accommodation chamber 2, thereby dissipating the accumulated heat inside and cooling the blade. The heat dissipation component 5 includes a fixed frame 51, the fixed frame 51 is inserted into the interior of the installation groove 4. The fixed frame 51 is configured to dock with the installation groove 4, and a baffle 52 is fixedly connected to the surface of the fixed frame 51. The baffle 52 is configured to limit the fixed frame 51. The baffle 52 is a square frame with a dust-proof net inside to prevent dust from entering. When cutting hair, it can prevent broken hair from entering. At the same time, the baffle 52 can prevent the fixed frame 51 from passing through the installation groove 4 and render the insertion slot correspond to the position of the insertion plate 64. A surface and a bottom of the fixed frame 51 are both fixedly connected with a protective strip 53, and a surface of the protective strip 53 is provided with a ventilation groove 54. The protective strip 53 is configured to install the rotating shaft 55. By setting with the ventilation groove 54, the ventilation effect is improved, the surface of the protective strip 53 is provided with a through hole that is penetrated, and the through hole is rotatably connected to a rotating shaft 55, the rotating shaft 55 penetrates and is fixedly connected to a surface of a circular plate 56. There are a plurality sets of blades 57 that are arranged in an array on a side wall of the circular plate 56. Through the cooperation between the circular plate 56 and the blades 57, the air flow can be accelerated during rotation. The circular plate 56 and blades 57 are arranged between two sets of protective strips 53, and the blades 57 are protected by the protective strip 53. A bottom of the rotating shaft 55 is fixedly connected with a second bevel gear 58, which meshes with the first bevel gear 31. The circular plate 56 is connected to the second bevel gear 58 through the rotating shaft 55, and first bevel gear 31 drives the second bevel gear 58 to rotate, thereby causing the blades 57 to rotate and dissipate heat.

There are four sets of positioning components 6 that are distributed in an array on the surface of the fixed frame 51. The positioning components 6 are configured to position the fixed frame 51, rendering a connection between the heat dissipation component 5 and the installation groove 4 more stable. The fixed frame 51 can also be fixed and installed inside the installation groove 4 by a screw. An internal threaded column connected to the screw is welded at four corners of the installation groove, and the screw is connected to the threaded column through a threaded connection. The positioning component 6 includes a sliding groove 61, the sliding groove 61 is provided on the surface of the fixed frame 51. An interior of the sliding groove 61 is slidably connected to a slider 62, the slider 62 is configured to guide a movement of the slider 62, so that the sliding groove 61 drives the insertion plate 64 to slide out from the corners of the fixed frame 51. The slider 62 is elastically connected to an inner wall of the sliding groove 61 through a reset spring 63, an end of the slider 62 is fixedly connected to an insertion plate 64. The insertion plate 64 penetrates and is slidably connected to a side wall of the fixed frame 51. The insertion plate 64 is inserted into an interior of the insertion slot and exerts an elastic force on the slider 62 through the reset spring 63, so that the insertion plate 64 is inserted into the insertion slot so as to fix the fixed frame 51. A plurality sets of grooves that are distributed in an array are provided on a surface of the slider 62. A height of the slider 62 is greater than a depth of the sliding groove 61. By providing the height of the slider 62 to be greater than the depth of the sliding groove 61, a top of the slider 62 extends beyond the sliding groove 61 and cooperates with the groove to facilitate the movement of the slider 62, the reset spring 63 is compressed, the insertion plate 64 can be extracted from the interior of the insertion slot, and the heat dissipation component 5 is removed.

In the present disclosure, when in use, the elastic force of the reset spring 63 on the slider 62 is used to insert the insertion plate 64 into the insertion slot, thereby fixing the fixed frame 51 and making the connection between the heat dissipation component 5 and the installation groove 4 more stable. By starting the hair clipper, an internal motor drives the electric shaft 3 to rotate, thereby rendering the blade work. By driving the first bevel gear 31 to rotate, the second bevel gear 58 that meshes with the first bevel gear 31 is rotated synchronously. The rotating shaft 55 connects the circular plate 56 with the second bevel gear 58, so that plurality sets of blades 57 are rotated, thereby accelerating the air flow inside the accommodation chamber 2, discharging the accumulated heat inside, and cooling the blade. By moving the slider 62, the reset spring 63 is compressed, thereby extracting the insertion plate 64 from the interior of the insertion slot and removing the heat dissipation component 5.

Although the embodiments of the present disclosure have been shown and described, it will be understood by those skilled in the art that various changes, modifications, substitutions, and variations can be made to these embodiments without departing from the principles and spirit of the present disclosure. The scope of the present disclosure is limited by the appended claims and their equivalents.

What is claimed is:

1. A hair clipper with an electric fan for heat dissipation, comprising a hair clipper housing,
wherein an end of the hair clipper housing is provided with an accommodation chamber, a side wall of the accommodation chamber is rotatably connected to an electric shaft; a first bevel gear is fixedly connected to an outer wall of the electric shaft;
a surface of the hair clipper housing is provided with an installation groove, the four sets of corners on an inner wall of the installation groove are respectively provided with an insertion slot; an interior of the installation groove is provided with a heat dissipation component, and the heat dissipation component comprises a fixed frame, the fixed frame is inserted into the interior of the installation groove;
a surface and a bottom of the fixed frame are both connected with a protective strip; a surface of the protective strip is provided with a ventilation groove; a through hole that is penetrated is provided on the surface of the protective strip, and the through hole is rotatably connected with a rotating shaft, the rotating shaft is penetrated and fixedly connected to a surface of a circular plate, a side wall of the circular plate is fixedly connected with a blade;
a bottom of the rotating shaft is fixedly connected with a second bevel gear, and the second bevel gear meshes with the first bevel gear.

2. The hair clipper with an electric fan for heat dissipation according to claim 1, wherein a positioning component is provided on a surface of the fixed frame, the positioning component comprises a sliding groove, the sliding groove is provided on the surface of the fixed frame, an interior of the sliding groove is slidably connected with a slider, and the slider is elastically connected to an inner wall of the sliding groove through a reset spring; an end of the slider is fixedly connected to an insertion plate, and the insertion plate penetrates and is slidably connected to a side wall of the fixed frame.

3. The hair clipper with an electric fan for heat dissipation according to claim 1, wherein a baffle is fixedly connected to a surface of the fixed frame.

4. The hair clipper with an electric fan for heat dissipation according to claim 1, wherein there are a plurality sets of blades that are distributed on the side wall of the circular plate in an array.

5. The hair clipper with an electric fan for heat dissipation according to claim 1, wherein the circular plate and blades are arranged between two sets of protective strips.

6. The hair clipper with an electric fan for heat dissipation according to claim 2, wherein the insertion plate is inserted into an interior of the insertion slot.

7. The hair clipper with an electric fan for heat dissipation according to claim 2, wherein a surface of the slider is provided with a plurality sets of grooves that are distributed in an array.

8. The hair clipper with an electric fan for heat dissipation according to claim 2, wherein a height of the slider is greater than a depth of the sliding groove.
